(19) United States
(12) Patent Application Publication
(10) Pub. No.: US 2018/0213421 A1
(43) Pub. Date: Jul. 26, 2018

(54) PREDICTING FUTURE SPECTRUM UTILIZATION

(71) Applicant: Microsoft Technology Licensing, LLC, Redmond, WA (US)

(72) Inventors: Eric Horvitz, Kirkland, WA (US); Ranveer Chandra, Kirkland, WA (US); Paul Koch, Redmond, WA (US)

(73) Assignee: Microsoft Technology Licensing, LLC, Redmond, WA (US)

(21) Appl. No.: 15/624,599

(22) Filed: Jun. 15, 2017

Related U.S. Application Data
(60) Provisional application No. 62/449,825, filed on Jan. 24, 2017.

(51) Int. Cl. H04W 24/08; H04W 74/08; H04W 16/14

(52) U.S. Cl. CPC H04W 24/08; H04W 16/14; H04W 74/08

(57) ABSTRACT

Methods for predicting future spectrum utilization are disclosed. Monitoring of spectrum signatures in a first system during a first time period may indicate that a particular frequency spectrum is being used by at least one device or second system for at least one type of application based on monitored spectrum usage. Knowledge of the monitored spectrum usage may be used to determine a prediction of how the frequency spectrum will be used in a second time period by the at least one device or second system, and the prediction may be utilized for selecting portions of the frequency spectrum for use in the first system during the second time period. The knowledge of the monitored spectrum usage may be combined with information in a database when determining the prediction of use.

### CROSS REFERENCES TO RELATED APPLICATIONS

The present application claims priority to and the benefit of co-pending U.S. Provisional Patent Application No. 62/449,825 filed Jan. 24, 2017, the entire contents of which are hereby incorporated by reference.

### BACKGROUND

Various types of wireless systems have been proposed which utilize channels in a frequency spectrum where the frequency spectrum may he shared with other systems. The sharing of frequency spectrum allows a wireless system to increase system bandwidth and communication efficiency when the shared frequency spectrum is available to the system. In various system designs, the shared frequency spectrum may be spectrum in unlicensed frequency bands or spectrum in licensed/allocated frequency bands of a system that ate shared with other systems, for example, on a prioritization basis.

An example of a system that utilizes spectrum in unlicensed frequency bands is a long term evolution unlicensed band (LTE-U) system. LTE-U is a technology that enables base stations and devices to operate using LTE technology on channels in the 5 GHz and 3.5 GHz unlicensed bands that are primarily used for Wi-Fi devices and systems. In operation of a LTE-U system, the LTE-U system must share the 5 GHz and/or 3.5 GHz spectrum with any Wi-Fi devices or systems, and other LTE-U systems, that are nearby or otherwise potentially interfering in the 5 GHz and/or 3.5 GHz spectrum. This sharing of spectrum creates the potential for interference between the devices and/or systems, and may result in inefficient spectrum utilization in the LTE-U or Wi-Fi systems.

Another example of a system utilizing shared frequency spectrum is a Dynamic Spectrum Access (DSA) system. A DSA system is typically configured to allow devices and base stations in the DSA system to use a frequency spectrum that is shared with other systems. When the shared frequency spectrum is available to the devices and base stations of the DSA system, the frequency spectrum may be used. The availability for use may be determined on a priority basis, for example one system may have priority of use, but a second system may be able to use the shared spectrum when the second system detects that the first system is not using the spectrum. The allocation of frequency spectrum for use in a DSA system may also be based on assignment information received from a DSA coordination database. This sharing of spectrum in DSA systems also creates the potential for interference between devices and/or networks and may result in inefficient spectrum utilization in DSA systems, especially if the spectrum sharing is not done in an efficient manner.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

The disclosed embodiments provide systems, methods, and apparatus for determining and utilizing a predication of future use of frequency spectrum that is potentially available to a system or device, where the predication is determined based on spectrum signatures determined in a first time period. The spectrum signatures determined in the first time period may be used to predict future behavior for frequency spectrum use in a second time period subsequent to the first time period. In an implementation, spectrum usage on one or more channels in a frequency spectrum may be monitored during a first time period and at least one parameter associated with the use of the one or more channels during the first time period may be determined based on the monitored spectrum. A prediction of use of the one or more channels for a second time period may be determined based on the at least one parameter. The at least one parameter may be combined with information in a data base to determine the prediction of use of the one or more channels. The prediction of use of the one or more channels for the second time period may then be used to determine channels to be used by the system or device.

For example, monitoring of spectrum signatures in a first system during a first time period may indicate that a particular frequency spectrum is being used by at least one device or second system for at least one type of application based on packet burst behavior. Knowledge of the at least one type of application may be used to determine a prediction of how the frequency spectrum would be used in a second time period by the at least one device or second system. The prediction then may be utilized for selecting portions of the frequency spectrum for use in the first system during the second time period. The knowledge of the at least one type of application may be combined with information in a database when determining the prediction of use.

In another example, monitoring of spectrum signatures in a first system during a first time period may indicate at least one pattern of duration of use of the frequency spectrum by at least one device/second system based on spectrum signatures. Knowledge of the at least one pattern of duration of use may he used to determine a prediction of how the frequency spectrum would be used by the at least one device or second system in a second time period and then be utilized in selecting portions of the frequency spectrum for the first system to use during the second time period. Knowledge of the at least one pattern of duration of use may be combined with information in a database when determining the prediction of use.

### BRIEF DESCRIPTION OF THE DRAWINGS

FIG. 1A is a diagram illustrating an example system using unlicensed frequency spectrum;

FIG. 1B is a simplified block diagram illustrating portions of example monitor apparatus of FIG. 1A;

FIG. 2A is a flow diagram illustrating example operations for determining predictions of spectrum usage;

FIG. 2B is a flow diagram illustrating example operations for generating a database used in determining predictions of spectrum use;

FIG. 3A is a diagram illustrating an example system using dynamic spectrum access;

FIG. 3B is a another flow diagram illustrating example operations for determining predictions of spectrum usage;

FIG. 4A is a diagram illustrating an example system using a carrier sense protocol for channel access;

FIG. 4B is a simplified block diagram illustrating portions of an example apparatus of FIG. 4A;

FIG. 5 is a flow diagram illustrating example operations fear determining back-off;

FIG. 6 illustrates an example implementation in which a system may include multiple spectrum monitors and/or databases;

FIG. 7 illustrates an example database service; and,

FIG. 8 is a simplified block diagram of an example device.

### DETAILED DESCRIPTION

The system, devices, and methods will now be described by use of example embodiments. The example embodiments are presented in this disclosure for illustrative purposes, and not intended to be restrictive or limiting on the scope of the disclosure or the claims presented herein.

The methods, systems, and apparatus of the embodiments provide technical advantages by allowing predictions for future frequency spectrum utilization to be determined from past frequency spectrum signatures, and utilized in a system for future frequency spectrum use. For example, frequency spectrum signatures may be used to monitor the utilization of selected frequency spectrum in the coverage area of a system over a first time period to determine whether the spectrum is utilized for a voice call, for packet data media streaming, for video audio conferencing, or used in particular patterns of durations of use. The use of the frequency spectrum in the coverage area of a system may include use by devices in the system itself or use by other devices/systems that also use the selected frequency spectrum. The determination of usage for the first time period may be used to determine a prediction of how the selected frequency spectrum will be utilized in a second time period subsequent to the first time period. Devices in the system may use the predictions to determine and/or assign channels in the selected frequency spectrum to minimize interference or conflicts with the other devices/systems.

The predictions of how frequency spectrum will be utilized may provide advantages in wireless net design and operation. For example, in eases where continuous channel switching onto and off shared channels may be expensive in terms of network resources, the predictions may be used to identify channels for use in a network where the channel have a higher chance of being free in the future to avoid channel switching.

Implementations of the embodiments have applicability to systems such as long term evolution-unlicensed (LTE-U systems, systems utilizing frequency spectrum in the television white space (TVWS), dynamic spectrum access (DSA) systems, and other systems in which frequency spectrum is shared.

Other implementations have applicability to systems such as contention sense packet data systems, for example Wi-Fi systems. In one implementation, first data traffic sent by at least one first device on a contention based packet data channel may be monitored during a first time period and at least one application type for the first data traffic may be determined from spectrum characteristics. At least one back-off parameter for second data traffic sent on the contention based channel by a second device may he determined from a prediction of use of the contention based channel in a second time period based on the at least one application type for the first data traffic. In one example implementation, the at least one application type may be determined by determining temporal characteristics of spectrum utilization for the first data traffic on the contention based channel and determining the at least one application type for the first data traffic based on the temporal characteristics. The temporal characteristics of spectrum utilization may include a correlation of the at least one signal carrying the first data traffic and/or a periodicity of the at least one signal carrying the first data traffic.

The predictions of how the frequency spectrum will be utilized may be made without decoding any frames to infer applications used by other devices. This may be advantageous in situations in which it might not be feasible to decode data packets, especially if the packets are encrypted or modulation techniques are not known. In one example implementation, the applications in use on the frequency spectrum, e.g. voice, video, broadcast, etc., may be determined based the temporal characteristics of the frequency spectrum utilization. The temporal pattern may be determined using correlation. In another example, a Fast Fourier Transform (FFT) may be used to determine a periodicity. To determine whether packets are coming from the same transmitter, transmissions from a base station may be observed. Since most traffic is bidirectional, if a device sends a data frame it would receive ACKs at the MAC layer, and also at the TCP layer after some time. Furthermore, since most communication goes through a centralized point, e.g. a base station, or a wireless router, every bidirectional communication block will have one transmission from the base station. Additionally, transmit power levels may be used to cluster devices with similar transit power levels for analysis.

The embodiments provide advantages in systems such as long term evolution unlicensed (LTE-U) systems. Because a channel change in a LTE-U system requires several control messages to be sent over the operator's network and may be disruptive to a packet data session, once use of an unlicensed channel is begun, lower probability of channel change is desirable. The implementations use a cognitive approach of trying to identify the usage, and duration of usage, of unlicensed frequency spectrum to predict the period of time for which a channel is expected to stay busy (or conversely unused in the future. The LTE-U system then operates on the channel with the best metric for being unused or less used in the future. This provides advantages over proposed LTE-U systems that rely on spectrum sensing to obtain instantaneous channel measurements and determine available spectrum. The instantaneous channel measurements provide no information related to potential future behavior on the channels and do not allow selection of a channel more likely to remain unused or less used by others in the future. The implementations also provide advantages as compared to listen-before-talk LIE-U devices that listen to channels for short periods of time and probabilistically cede to other devices if they are present, as listen-before-talk LTE-U devices also do not take potential future behavior on channels into account. The implementations of the embodiments also provide advantages over static channel assignment methods, which take neither current nor future behavior on potentially interfering channels into account. The embodiments have potential use in other networks, for example, gamine, device wireless controller networks, Wi-Fi display networks (such as Miracast), and any other wireless links or communications networks that may benefit from use of the embodiments.

The embodiments also provide advantages in Dynamic Spectrum Access (DSA) systems. One existing approach to channel assignment in DSA requires a device to communicate with a database in the cloud to receive information on available frequency spectrum. The DSA database has static entries that preclude fine-grained usage of frequency spectrum over short time periods. Frequency spectrum sensing is another approach that may also be used in DSA systems. However frequency spectrum sensing, as in LIE-U, only provides instantaneous information about frequency spectrum use. These existing approaches do not allow estimation of the future usage of frequency spectrum from current usage, and use frequency spectrum that is likely to remain unused in the future.

Additionally advantages are provided in systems using carrier sense protocols such as Wi-Fi systems. In carrier sense protocol systems, a device having a data packet to send must sense a channel for activity, and if the channel is busy, back-off by inhibiting transmission of the data packet for a defined back-off time period. Although the carrier sense protocol is simple, it is inefficient and leads to long periods of protocol overhead when the channel is not in use, and therefore wastes resources. In an implementation of the embodiments, contention on a channel may be made application aware. The channel may be monitored during a first time period and at least one application type for the data traffic on the channel may be determined. The device may then adjust its back off time based on the type of applications using the channel. For example, the device may not need to back off for its whole defined back off period if the device knows it is contending with voice traffic in which voice data packets are spaced by approximately 20 ms. Similarly, the device may avoid transmission when the voice packet is due to be sent based on the knowledge of the voice data packet frequency.

Systems, methods, and apparatus may be implemented in various configurations. For example, an apparatus according to the embodiments may be configured in a mobile device that may operate in a system using shared spectrum. The apparatus may determine channel assignments by performing methods of the embodiments, and make the predictions and/or channel assignments available to the device for use. In another example, an apparatus may be configured in a base station or as a stand-alone device in a system using shared spectrum, and the base station or stand-alone device may determine channel use predictions and/or channel assignments for devices operating in the system according to the methods of the embodiments. In another example, an apparatus may be configured as a remote server that collects data from remote measurement devices in at least one system, determines channel use predictions and/or channel assignments according to the embodiments, and provides the channel use predictions and/or channel assignments to devices for use in the at least one network.

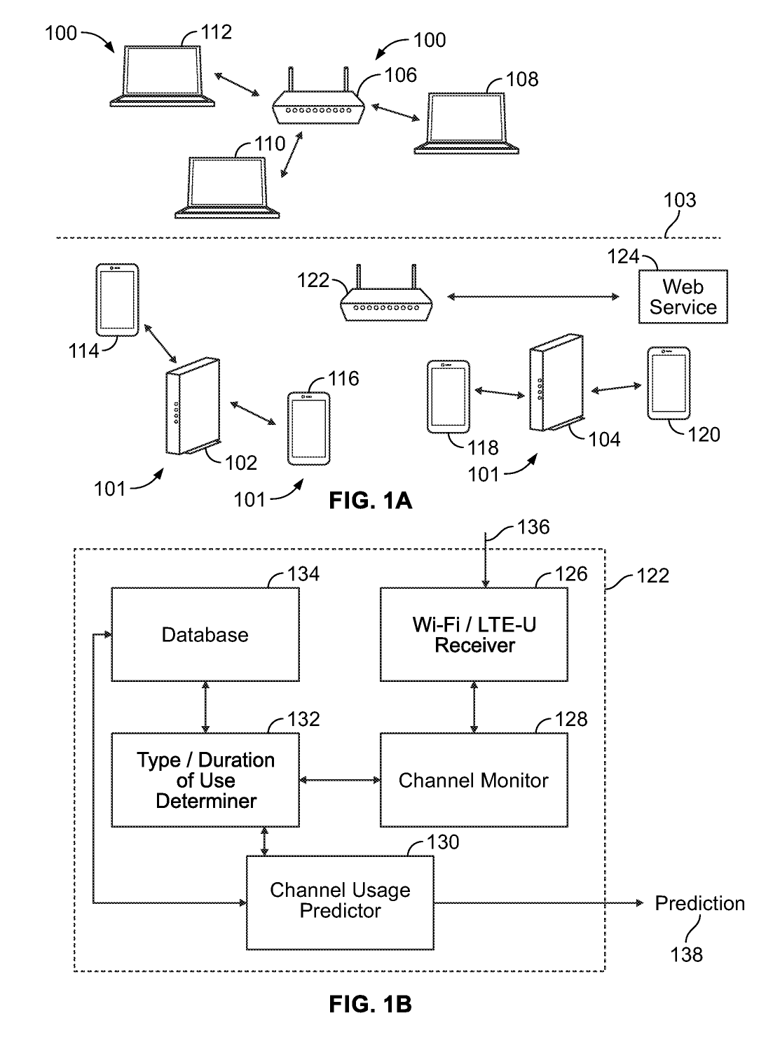

FIG. 1A is a diagram illustrating an example system into which an embodiment of the disclosure may be implemented. FIG. 1A shows system 101 that includes base stations 102 and 104 located in the area below broken line 103. Base stations 102 and 104 are shown communicating with devices 114 and 116, and, devices 118 and 120, respectively, over wireless channels. System 101 also includes monitor apparatus 122 that that is located within the coverage area of base stations 102 and 104, and is connected to a web service 124. Web service 124 may be located remotely from system 101 in a cloud server device or may be configured in system 101, for example as integrated into monitor apparatus 122. System 101 is shown adjacent to a neighboring system 100, which includes access point 106 located in the area above broken fine 103, and devices 108, 110, and 112. Devices 108, 110, and 112 may be devices such as laptops or desktop PCs that communicate with access point 106 over wireless channels. In an implementation of system 101, system 101 may be a LTE-U system and base stations 102 and 104 may communicate with devices 114, 116, 118, and 102 in the 5 GHz and/or 3.5 GHz unlicensed bands. Adjacent system 100 may he a system operating according to the IEEE 802.11 Wi-Fi specifications, and access point 102 may communicate with devices 108, 110, and 112 on channels in the 5 GHz and/or 3.5 GHz unlicensed bands. Radio transmission from access point 106, and devices 108, 110, and 112, may radiate into the area below broken line 103 and interfere with system 101. Additionally, other systems (not shown) such as LTE-U or Wi-Fi systems may generate radio transmissions in the 5 GHz and/or 3.5 GHz unlicensed bands that radiate into the area of system 101.

FIG. 1B is a simplified block diagram illustrating portions of example monitor apparatus 122 of FIG. 1A. Monitor apparatus 122 includes Wi-Fi/LTE-U receiver 126, channel monitor 128, database 134, type/duration of use determiner 132, and channel usage predictor 130. in operation, channel monitor 128 monitors spectrum usage on one or more channels in the 5 GHz and 3.5 GHz unlicensed bands, type/duration of use determiner 132 determines at least one parameter associated with use of the one or more channels, and channel usage predictor 130 determines predictions of use of the one or more channels based on the at least one parameter and information in data base 134, and makes the predictions 138 available to base stations 102 and 104.

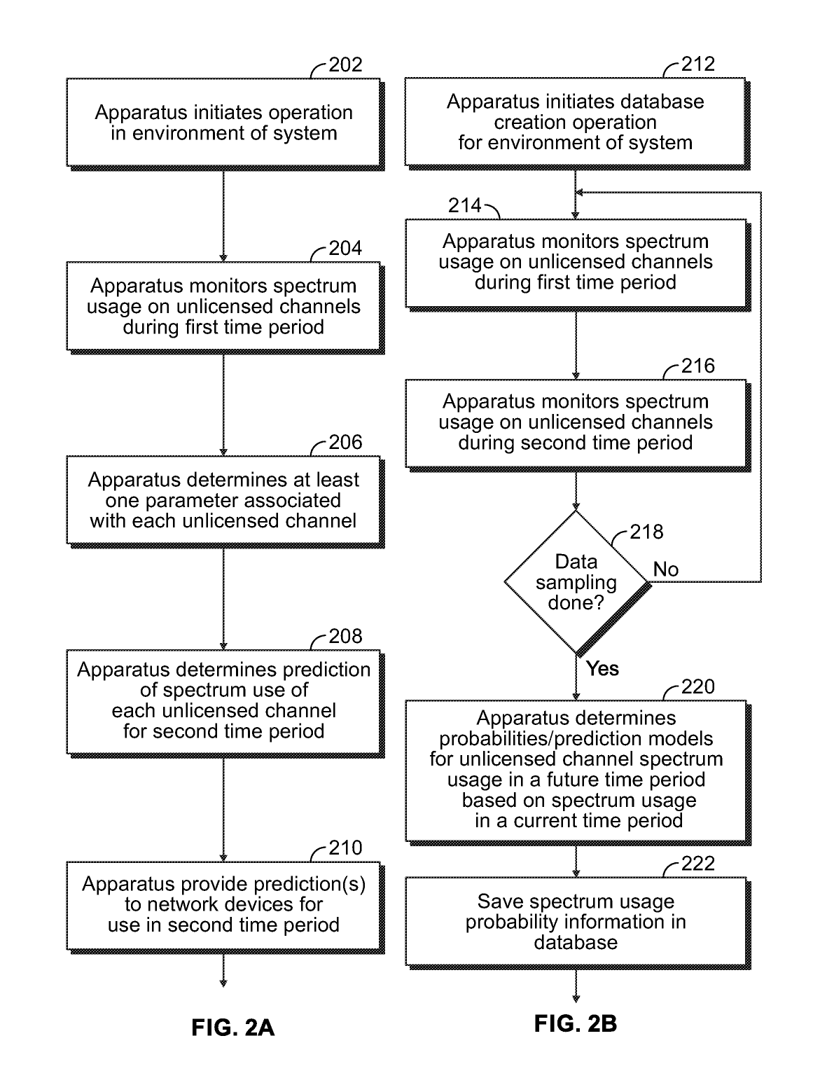

FIG. 2A is a flow diagram illustrating example operations performed by monitor apparatus 122 for determining predictions of spectrum usage. The process begins at 202 where motor apparatus 122 initiates operation in the coverage area/environment of system 101. At 204, monitor apparatus 122 monitors spectrum usage on one or more channels in the 5 GHz and 3.5 GHz unlicensed bands. Monitor apparatus may monitor the spectrum usage by measuring spectral characteristics on one or more channels of the spectrum during a first time period. The measuring of the spectral characteristics may include performing correlation or periodicity measurements. The measuring of the spectral characteristics may also include performing measurements for determining durations of use/nonuse of the one or more channels during the first time period.

At 206, monitor apparatus 122 determines at least one parameter associated with each of the one or more channels. The parameters may comprise data/information associated with duration of use and/or type of use of the spectrum. For example, the parameter may include information on durations of use/nonuse of the spectrum on the one or more channels during the first time period. The information on durations of use/nonuse maybe determined from measurements performed at operation 204. The parameters may also include information on type of use, such as estimations of what types of applications/data traffic are using the one or more channels during the first time period. The types of applications/data traffic may be determined from temporal characteristics of the one or more channels during the first time period. The temporal characteristics may be determined from correlations, periodicity measurements or measurements of durations of use/nonuse performed at operation 204. The determined parameters determined at 206 may include combined information on type of use and/or duration of use during the first time period.

At 208, monitor apparatus 122 determines a prediction for use of the one or more channels in the unlicensed spectrum for a second time period based on the parameters determined at 206 for the first time period and information in database 134. The information in database 134 may include probability information/prediction models for spectrum usage in system 101 generated from different historical values of the parameters, or information/prediction models based on values of the parameters that arc associated with various types of applications or data traffic. The information/prediction models may comprise any type of information that may be used to predict or estimate the use of the one or more channels in the second period based on the monitored use in the first time period. The historical information on spectrum usage may include information on how spectrum or channels may be utilized in a second time period as related to values of parameters in a first time period. The information/prediction models based on the values of the parameters associated with different types of applications or data traffic may include information on how spectrum or channels may be utilized by the types of applications or data traffic in a second time period as related to values of parameters in a first time period. For example, the information on transmission parameters/behavior may include information defined by specifications related to the types of applications or data traffic. In an implementation, the second time period may be a time period immediately after, or a relatively short time after, the first time period. The spacing between the first and second time period may be short enough so that the prediction based on the first time period will be valid for the second time period. This allows the prediction for the second time period to include effects of device/application behavior in the first time period that may directly impact channel use in the second time period.

At 210, monitor apparatus 122 provides or make the predictions available to base stations 102 and 104. Base stations 102 and 104 may then utilize the predictions in selecting channels to use for communications with devices 114, 116, 118, and 120. Spectrum monitor apparatus 122 may also provide data on spectrum usage/predictions to web service 124 and web service 124 may perform further analysis/data collection for use by system 101 and other LTE-U systems. Web service 124 may also provide updated information to monitor apparatus 122 to allow monitor apparatus 122 to update database 134 with current information on standards, application/data traffic behaviors, etc.

In other implementations, the functions shown in FIG. 1B may be allocated between spectrum monitor apparatus 122 and web service 124 in various ways. For example, spectrum monitor apparatus 122 may provide measurement data on the one or more channels in the 5 GHz and/or 3.5 GHz unlicensed bands to web service 124 and web service 124 may determine the predictions. Web service 124 may provide or make the predictions available to base stations 102 and 104 for utilization in selecting channels to use for communications. In further implementations, instead of providing predictions of channel usage to base stations 102 and 104, spectrum monitor apparatus 122 or web service 124, may determine and provide, or make the channel assignments available to base stations 102 and 104.

FIG. 2B is a flow diagram illustrating example operations for generating a database used in determining predictions of spectrum use. The operations of FIG. 2B may be used, for example, in, generating information for database 134 that is used in, the operations of FIG. 2A. The process begins at 212 where monitor apparatus 122 initiates operations in the coverage area/environment of system 101. At 214, monitor apparatus 122 monitors spectrum usage on one or more channels in the 5 GHz and 3.5 GHz unlicensed bands during a first time period to generate first sampling data. Monitor apparatus 122 may monitor the spectrum usage by measuring spectral characteristics on one or more channels of the spectrum during the first time period and generating first sampling data. The measuring of the spectral characteristics may include performing correlation or periodicity measurements. The measuring of the spectral characteristics may also include performing measurements for determining durations of use/nonuse or types of use of the one or more channels during the first time period. Next, at 216, monitor apparatus 122 monitors spectrum usage on one or more channels in the 5 GHz and 3.5 GHz unlicensed bands during a second time period to generate second sampling data. The first and second time periods used in the process of FIG. 2B may he of the same duration as the first and second time periods used in FIG. 2A. The relative timing and spacing of the first and second time periods in FIG. 2B may also he the same as used for the first and second time periods in the process of FIG. 2A. Monitor apparatus may monitor the spectrum usage at 216 by measuring spectral characteristics on one or more channels of the spectrum during the second time period. The measuring of the spectral characteristics may include performing correlation or periodicity measurements and generating second sampling data. The measuring of the spectral characteristics may also include performing measurements for determining durations of use/nonuse and types of use of the one or more channels during the second time period. Next, at 218, monitor apparatus determines if data sampling is completed. If it is determined that data sampling is not completed, the process moves to 214. Operations 214, 216, and 218 are then repeated until it is determined at 218 that data sampling is completed. A plurality of first and second time periods may be sampled to generate data. When it is determined at 218 that data sampling is completed the process moves to 220.

At 220, monitor apparatus 122 determines probability information/prediction models for usage of the one or more unlicensed channels in a future time period based on the actual usage in a current time period using the first and second sampling data. The probability information/prediction models may be based on correlations between the usage indicated by the first sampling data for each of the plurality of first time periods and the usage indicated by the associated second sampling data for an associated second time period. The probability information/prediction models may predict channel usage in a future time period based on durations of use/nonuse and types of use in a current time period. At 222, monitor apparatus 122 may then save the probability information/prediction models in database 134. The probability information/prediction models may be used in the process of FIG. 2A. For example, monitor apparatus 134 may determine predictions of channel usage in a future time period (second time period of operation 208) based on durations of use/nonuse and types of use in a current time period (first time period of operation 204) using the probability information/prediction models saved in database 134.

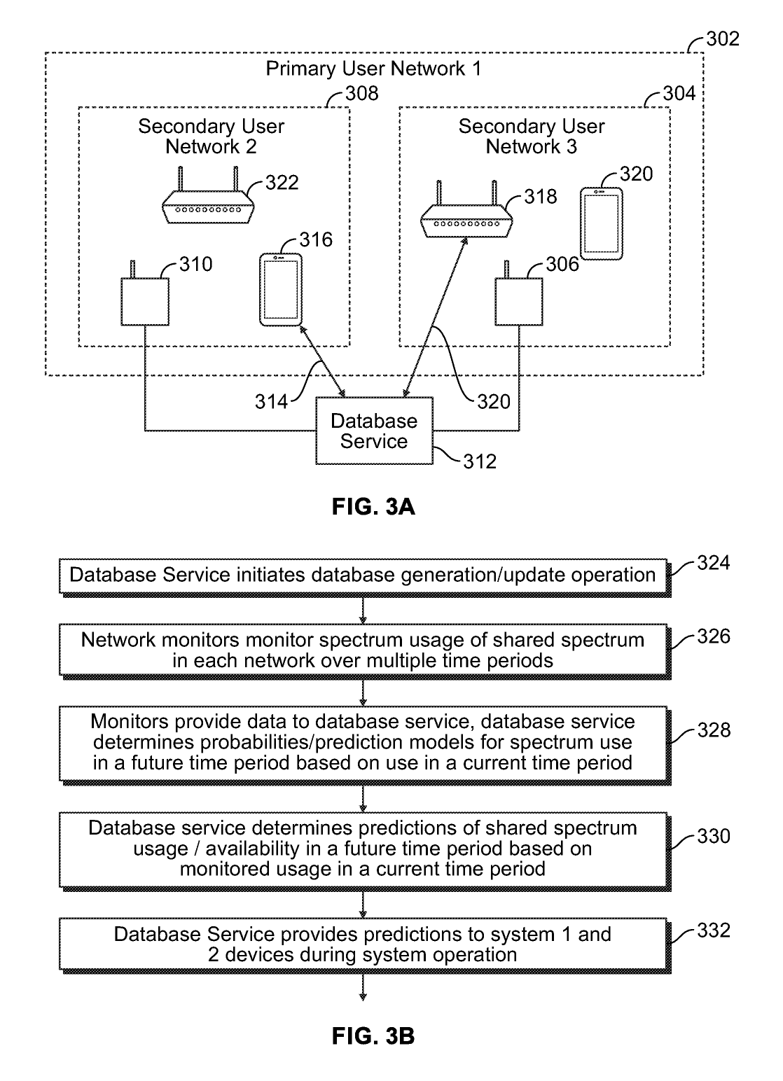

FIG. 3A is a diagram illustrating example systems using dynamic spectrum access (DSA). FIG. 3A shows system 302, which is the primary or priority user of shared frequency spectrum, and systems 304 and 308, which are the secondary users of the shared frequency spectrum. Systems 304 and 308 are located in die coverage area of system 302. System 302 includes devices and/or base stations (not shown) that operate within the coverage area of system 302 using channels in the shared frequency spectrum. System 308 includes base station 322 and device 316. System 304 includes base station 318 and device 320. FIG. 3A also shows database service 312. Database service 312 may collect measurements/data from monitors 306 and 310 which are located in the coverage areas of systems 304 and 308, respectively. Database service 312 may be implemented on one or more servers in the cloud, or on a local server device. In an alternative implementation, each of system 304 and 308 may have its own separate database service.

FIG. 3B is a flow diagram illustrating operations for determining probabilities/predictions for shared spectrum usage for use in systems 304 and 308. The probabilities/predictions for use in each system 304 or 308 may be jointly determined based on information from both systems 304 and 308. The operations of FIG. 3B may be performed by database service 312 and monitors 306 and 310.

The process begins at 324 where database service 312 initiates a database generation/update operation. At 326, monitors 306 and 310 monitor usage of the shared frequency spectrum over multiple time periods. This may include monitoring usage of the shared frequency spectrum at both monitors 306 and 310 when all of networks 302, 304, or 308 are using the spectrum. It also may include periods when only network 302 is using the spectrum. It may also include monitoring at monitor 306 when only networks 302 and 308 are being used, or monitoring at monitor 310 when only networks 302 and 304 are being used. The monitoring at 326 may include measuring spectral characteristics on one or more channels of the shared frequency spectrum during multiple time periods. Each of the multiple time periods may be divided into a first and a second time period. The second time period may be a time period immediately following the first time period. The measuring of the spectral characteristics may include performing correlation or periodicity measurements and generating first and second sampling data, for the first and second time period, respectively. The measuring of the spectral characteristics may also include performing measurements for determining durations of use/nonuse and types of use of the one or more channels during the first and second time periods of each multiple time period. The monitoring of operation 326 during the multiple time periods may be performed over a measurement period of hours, days or weeks. The multiple time periods comprising the first and second time periods may be much shorter in length than the measurement period so that a large number of samples may be obtained.

At 328, monitors 306 and 310 provide data on the measurement results of operation 326 to database service 312. Database service 312 uses the measurement results to determine prediction models for frequency spectrum use in a future time period based on use in a current time period. The prediction models may be determined for use jointly for systems 304 and 306, or individually for each of system 304 and 306. The probability information/prediction models may be based on correlations between the usage indicated by the first sampling data for each of the plurality of first time periods and the usage indicated by the associated second sampling data for an associated second time period. The probability information/prediction models may predict channel usage in a future time period based on durations of use/nonuse and types of use in a current time period. Database service 312 may then save the probability information/prediction models.

Next at 330, as systems 304 and 308 operate, database service 312 determines predictions of shared spectrum usage/availability in a second time period based on monitored usage in a first time period. Database service 312 may receive data on monitored shared frequency spectrum usage from monitors 306 and 310. Monitors 306 and 310 may measure spectral characteristics on one or more channels of the spectrum during the first time period. The measuring of the spectral characteristics may include performing correlation or periodicity measurements. The measuring of the spectral characteristics may also include performing measurements for determining durations of use/nonuse of the one or more channels during the first time period. Database service 312 may determine one or more parameters associated with each of the one or more channels. The parameters may comprise data/information associated with duration of use and/or type of use of the spectrum. For example, the parameter may include information on durations of use/nonuse of the spectrum on the one or more channels during the first time period. The parameters may also include information on type of use, such as estimations of what types of applications/data traffic are using the one or more channels during the first time period. The types of applications/data traffic may be determined from temporal characteristics of the one or more channels during the first time period. The temporal characteristics may be determined from correlations, periodicity measurements or measurements of durations of use/nonuse performed at operation 204. The determined parameters may include combined information on type of use and/or duration of use during the first time period. Database service 312 may then determine predictions for use of the one or more channels in the unlicensed spectrum for a second time period based on the parameters determined for the first time period and the information stored in its database. The information in the database includes the probability information/prediction models for spectrum usage in systems 302, 204, and/or 308 generated from different historical values of the parameters, or information on transmission parameters/behavior of various types of applications or data traffic monitored at operation 326. The historical information on spectrum usage may include information on how spectrum or channels may be utilized in a second time period as related to values of parameters in a first time period. The information on transmission parameters/behavior of various types of applications or data traffic may include information on how spectrum or channels may be utilized by the types of applications or data traffic in a second time period as related to values of parameters in a first time period based on technical estimations and/or as defined by specifications related to the types of applications or data traffic.

At 332, database service 312 may provide, or make available, the predictions of use of the one or more channels in the shared frequency spectrum for the second time period to devices in network 304 and 306 to allow selection of channels in the shared frequency spectrum that are most likely not used by other networks in the second time period. For example, database service 312 may provide predictions to access point 318 of system 304 over channel 320 at time intervals, or upon a receiving a request from access point 308. Access point 308 may then use the predictions to select one or more channels for use in system 304. In another example, database service 312 may provide predictions to device 316 of system 308 over channel 314 at time intervals, or upon a receiving a request from device 316. Device 316 may then use the predictions to select one or more channels for use in system 308.

In another implementation of the embodiments, first data traffic sent by at least one first device on a carrier sense protocol based packet data channel may be monitored during a first time period. At least one application type for the first data traffic may then be determined from the monitored spectrum characteristics. Next, based on the at least one application type for the first data traffic, a prediction of use of the contention based channel by the at least one first device in a second time period may be determined. Then, at least one back-off parameter for second data traffic sent by a second device in a second time period may he determined from the prediction of use of the contention based channel by the at least one first device.

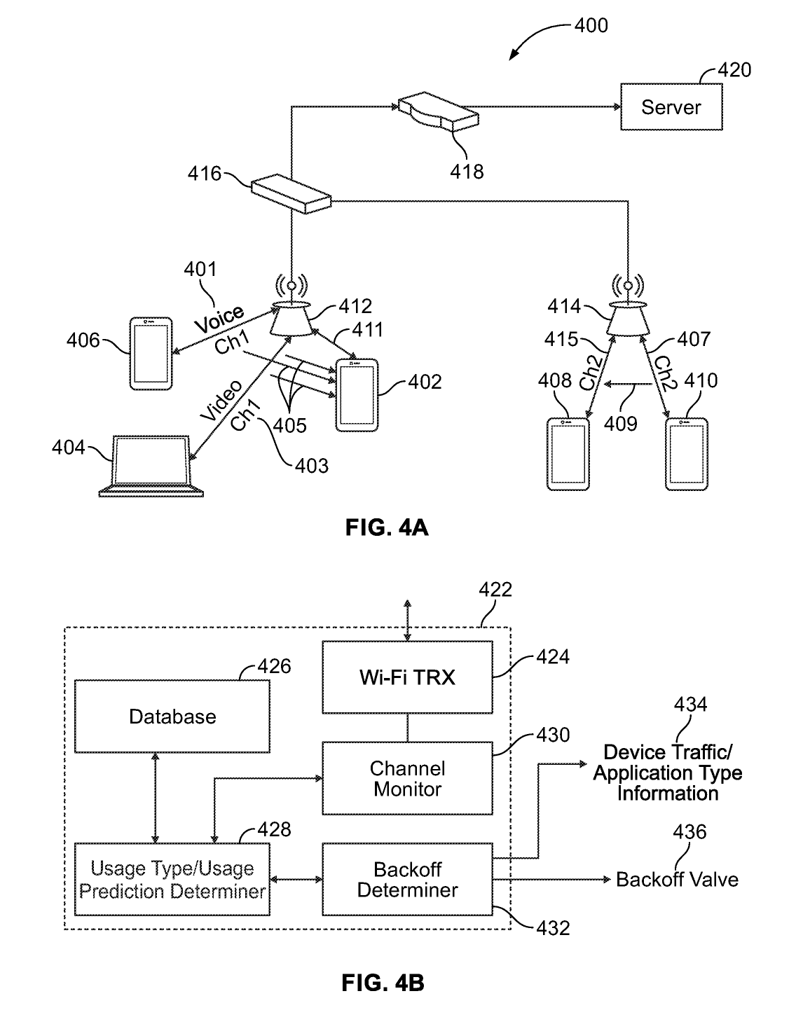

FIG. 4A is a diagram illustrating an example system using a carrier sense protocol for channel access. FIG. 4A shows system 400 which includes access points 412 and 414. Access point 412 is shown communicating data comprising voice data 401 with device 406 on a channel 1 (Ch1) and communicating data comprising video data 403 with device 404 on channel 1. Access point 412 is also shown communicating data 411 with device 402 over channel 1. Access point 414 is shown communicating data comprising application data 407 with device 410 over channel 2 (Ch2). Access point 414 is also shown communicating data 415 with device 408 over channel 2. In an example implementation, access points 412 and 414, and devices 402, 404, 406, 408, and 410 may operate according to the IEEE 802.11 Wi-Fi standards. Channel 1 and channel 2 may be contention sense packet channels according to IEEE 802.11.

FIG. 4B is a simplified block diagram illustrating portions of an example apparatus for use in the system of FIG. 4A. FIG. 4B may represent, for example, a portion of device 402. Portion 422 includes Wi-Fi transceiver (TRX) 424, channel monitor 430, database 426, usage type/usage prediction determiner 428, and backoff determiner 432. Back off determiner 432 may receive device traffic type information 434 which may comprise, for example, information from an application on another portion of device 402 about the type of traffic that device 402 currently is transmitting. Portion 422 functions to monitor channels of a Wi-Fi network used by other devices, determine a backoff value, and provide the backoff value 436 to a controller of device 402 for use in transmitting data. Device 408 may also be implemented having similar functions as shown in FIG. 4B.

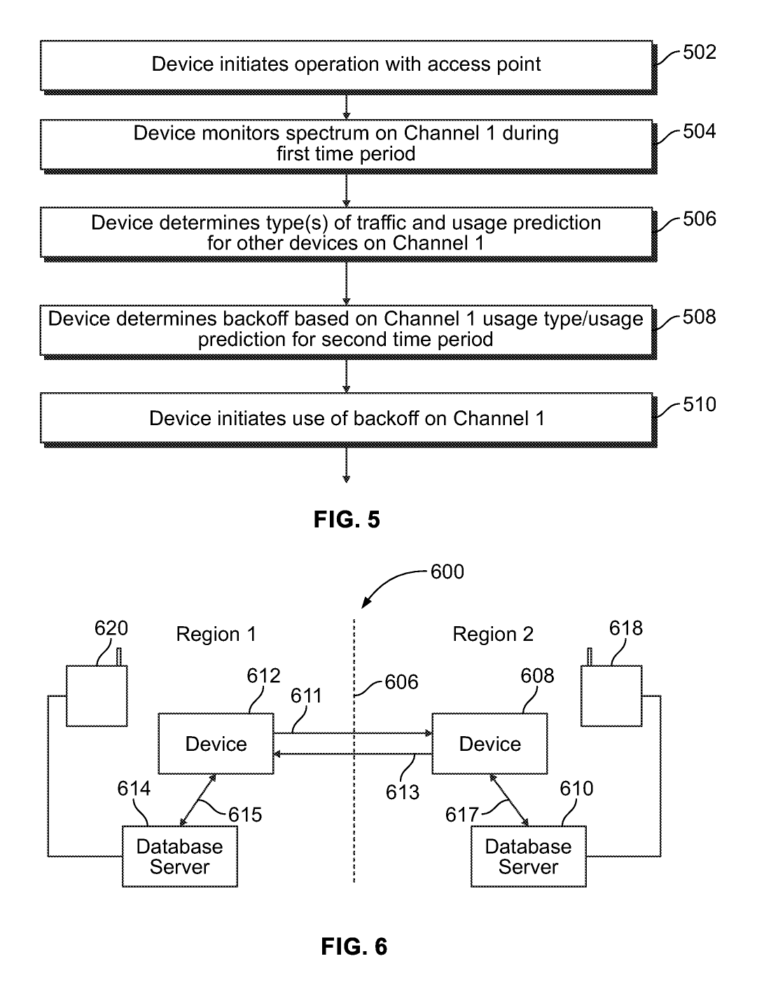

FIG. 5 is a flow diagram illustrating example operations for determining back-off in an example device such as device 402 of FIG. 4. FIG. 5 may be explained with reference to FIGS. 4A and 4B, and device 402.

The process begins at 502 when device 102 moves into the coverage area of access point 412 and initiates operation on channel 1 with access point 412. At 504, channel monitor 430 of device 402 begins to monitor spectrum usage by other devices in system 400 on channel 1 during a first time period using Wi-Fi TRX 424. Monitor 430 may monitor signals 405 on channel 1 that are picked up from the voice communications between access point 412 and device 406, and the video communications between access point 412 and device 404. Monitor 430 may also monitor any other signals that it may receive on channel 1 such as signals from other Wi-Fi systems.

At 506, usage type/usage prediction determiner 428 determines the types of data traffic of other devices on channel 1. in one example implementation, the types of data traffic on channel 1, e.g. voice data traffic of device 406, video data traffic of device 404, etc., may be determined based the temporal characteristics of the frequency spectrum utilization. For example, the temporal pattern may be determined using correlation. In another example, a Fast Fourier Transform (FFT) may be used to determine a periodicity of the data traffic transmissions. The temporal characteristics of the frequency spectrum utilization may then be compared with data in database 426 to make an estimation of the type of the one or more types of data traffic on channel 1. To determine whether packets are coming from the same transmitter, transmissions from access point 412 may be observed. Since most traffic is bidirectional, if device 402 or 404 sends a data frame it would receive ACKs at the MAC layer, and also at the TCP layer after some time. Because the data traffic goes through the centralized point of an access point, every bidirectional communication block will have one transmission from the access point 412. Additionally, transmit power levels may be used to duster devices with similar transit power levels for analysis.

Also, at 506, usage type/prediction determiner 428 determines a prediction of usage for channel 1 during a second time period based on the determined types of data traffic for devices 404 and 406 on channel 1 during the first time period. Usage type/prediction determiner 428 may access data stored in database 426 associated with the determined types of data traffic and/or the temporal characteristics of the data traffic to determine the prediction of usage for channel 1. The data in database 426 may include historical monitored data collected over past time periods for various types of data traffic. The data in database 426 may also include other data associated with transmission behavior of particular types of data traffic such as data on standards defined backoff timing. For example, a prediction of data packet transmission times on channel 1 in the second time period may be determined for the voice data traffic and video data traffic of devices 404 and 406 to predict a best time for device 402 to transmit on channel 1. Usage type/prediction determiner 428 may then provide the prediction to backoff determiner 432.

At 508, backoff determiner 432 may use the prediction to determine backoff timing for data packet transmissions from device 102 and provide the backoff value 436 to a controller of device. Device 102 may then adjust its backoff time based on the type of other applications using channel 1. For example, device 102 may not need to back off for its whole defined back off period if it predicted to be only contending with voice traffic between device 406 and access point 412 during the second time period, where the voice traffic data packets may be predicted to be transmitted every 30 ms. Device 102 may also adjust backoff to avoid transmission when the voice data packet is due to be sent. Backoff determiner 432 may use the device traffic/application type information 434 of device 102 in determining the backoff value.

FIG. 6 illustrates an example implementation in which a system may include multiple spectrum monitors. FIG. 6 shows system 600 including region 1 in which device 612 is operating and region 2 in which device 608 is operating. Regions 1 and 2 may be geographic areas (divided by broken line 606) that include monitors 620 and 618, respectively. Monitors 620 and 618 are connected to database servers 614 and 610, respectively. Regions 1 and 2 may each be a region within system 600. Each region of system 600 may support multiple devices (not shown), for example, base stations and mobile devices, operating in that region. System 600 may be implemented across regions 1 and 2, allowing mobile devices to roam between regions 1 and 2 while operating in communication with base stations in either region 1 or 2. For example, in FIG. 6 device 612 may be a mobile device communicating with device 608, which may be a base station, on uplink channel 611 and downlink channel 613. Device 612 may be located at a distance great enough from device 608 so that both device 612 and device 608 are located in different regions of system 600. Regions 1 and 2 may be defined by a system operator and monitors 620 and 618 may be placed based on the fact that different interference patterns exist on system channels in regions 1 and 2 because of geography or, otherwise. Monitors 620 and 618 may be implemented to monitor spectrum usage on one or more system channels in their respective regions during a first time period and provide monitoring results to databases 614 and 610, respectively. Database servers 614 and 610 then may determine and provide predictions of spectrum use over links 615 and 617 to devices such as devices 612 and 608, respectively. For example. monitor 620 and database server 614 may perform the operations of FIGS. 2A and 2B in an unlicensed band to provide the predictions of spectrum use. Similarly, monitor 618 and database server 610 may also perform the operations of FIGS. 2A and 2B in the unlicensed band to provide the predictions of spectrum use. In another example, monitors 620 and 618 may perform the operations of FIGS. 2A and 2B in another frequency hand, for example in a DSA frequency band or TVWS frequency band used by devices in system 600.

In the scenario of FIG. 6, because device 612 and device 608 each will receive predictions of spectrum use from database servers 614 and 610, respectively, based on different regions, devices 612 and 608 may each determine different channels to use. In this case, devices 612 and 608 may be configured to communicate with each other and negotiate a mutually agreed upon channel based upon different predictions used by each of device 612 and 608.

In another example implementation of FIG. 6, each of database servers 614 and 610 may determine a channel assignment from the predictions of spectrum use and provide the channel assignments to devices 612 and 608, respectively. Devices 612 and 608 may be configured to communicate with each other and negotiate a mutually agreed upon channel based upon the different channel assignments provided to each of device 612 and 608.

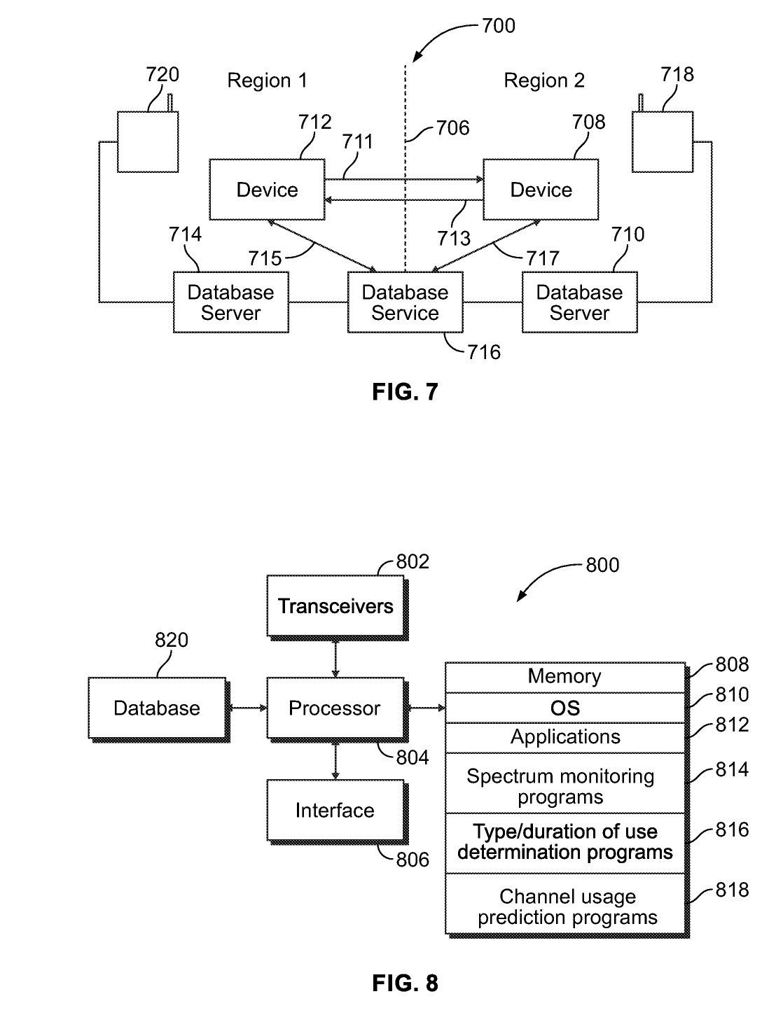

FIG. 7 illustrates an example database service in a system that includes multiple spectrum monitors. In FIG. 7, monitors 720 and 718, devices 712 and 708, and database servers 714 and 710 may function similarly to monitors 620 and 618, devices 612 and 608, and database servers 614 and 610 of FIG. 6, except that the predictions determined in database servers 714 and 710 are provided to database service 716 instead of directly to devices 712 and 708. Database service 716 then operates on the predictions provided by database servers 714 and 710 to generate a joint prediction that resolves conflicting predictions and/or removes incompatible channels and is suitable for use by both of devices 712 and 708. In another implementation, database service 716 may generate an acceptable joint channel assignment from the predictions provided by database servers 714 and 710 and provide the joint channel assignment to devices 712 and 708. Devices 712 and 708 may be configured to communicate with each other and negotiate a mutually agreed upon channel based upon the joint predictions or joint channel assignment provided to each of device 712 and 708.

FIG. 8 is a simplified block diagram of an example device 800. In an example implementation, device 800 may be implemented as a monitor apparatus such as monitor apparatus 122 of FIG. 1A. In other example implementations, device 800 may be implemented as device 402 of FIG. 4A, as monitor apparatus 620 (618) combined with database server 614 (610) of FIG. 6, or as monitor apparatus 720 (718) combined with database server 714 (710) of FIG. 7.

Device 800 may include a processor 804, memory 808, interfaces 806, database 820 and transceivers 620. Memory 808 may be implemented as any type of computer readable storage media, including non-volatile and volatile memory. Memory 808 is shown as including program code comprising device operating system (OS) 810, device applications 812, spectrum monitoring programs 814, type/duration of use determination programs 816, and channel usage prediction programs 818. Processor 804 may comprise one or more processors, or other control circuitry; or any combination of processors and control circuitry, The spectrum monitoring programs 814, type/duration of use determination programs 816, and channel usage prediction programs 818 may provide the functions shown, for example, in device 122 in FIG. 1B. When executed, spectrum monitoring programs 814, type duration of use determination programs 816, and channel usage prediction programs 818 may cause processor 804 to control device 800 to perform processes described in relation to FIGS. 2A, 2B, 3B, and 4. Database 820 may comprise a database including probabilities/prediction models for spectrum usage that are created according to FIG. 2B. Interfaces 806 may include an interface that communicates input/output wirelessly, or any other type of interface that communicates input/output to or from device 800 for performing the operations of the embodiments. In one example implementation, device 600 may operate according to half-duplexed communications standard. For example, device 800 may operate using half-duplex channels according to the IEEE 802.11 standards. In other example implementations, device 800 may operate to receive signal on channels in the LTE-U frequency bands, the TVWS, or on channels in a designated DSA frequency spectrum.

The example embodiments disclosed herein may be described in the general context of processor-executable code or instructions stored on memory that may comprise one or more computer readable storage media (e.g., tangible non-transitory computer-readable storage media such as memory 808). As should be readily understood, the terms “computer-readable storage media” or “non-transitory computer-readable media” include the media for storing of data, code and program instructions, such as memory 808 and do not include portions of the media for storing transitory propagated or modulated data communication signals.

While example implementations have been disclosed and described as having functions implemented on particular wireless devices operating in particular types of networks, one or more of the described functions for the devices may be implemented on a different one of the devices than shown in the figures, or on different types of equipment operating in different systems. For example, the embodiments disclosed in the implementations of FIGS. 1-8 maybe implemented in any other type of device, apparatus or system. For example, the disclosed embodiments have application in Wi-Fi Miracast devices/networks, gaming device wireless controller devices/networks, device to device (D2D) communications, and any other devices and/or networks in which channel/spectrum selection or assignment for transmission and/or reception is performed.

The disclosed embodiments include an apparatus comprising memory in communication with the one or more processors, the memory including code that, when executed, causes the one or more processors to control the apparatus to monitor spectrum usage on one or more channels during a first time period, determine at least one parameter associated with use of the one or more channels during the first time period based on the monitored spectrum usage, determine a prediction of use of the one or more channels for a second time period based at least on the at least one parameter and information comprising a prediction model, and, provide the prediction to a device for use in the second time period. The at least one parameter may comprise at least one duration of use, and the prediction model may comprise a history of durations of use of the monitored spectrum in at least one third time period compared to durations of use in at least one fourth time period. The at least one parameter may comprise at least one type of use, and the prediction model comprises a history of types of use of the monitored spectrum in at least one third time period compared to durations of use in at least one fourth time period. The at least one parameter may comprise at least one type of use and at least one duration of use, and the code may further cause the one or more processors to control the apparatus to determine the prediction of use of the one or more channels based on the at least one type of use and the at least one duration of use. The one or more channels may comprise a first and second one or more channels, and the at least one parameter associated with use of the one or more channels may comprise at least one parameter associated with use of the first one or more channels in a first network, and at least one parameter associated with use of the second one or more channels in a second. network. The at least one parameter may comprise at least one type of use and the code may cause the one or more processors to control the apparatus to determine the at least one parameter by controlling the device to determine temporal characteristics of spectrum utilization associated with use of the one or more channels, and, determine at least one type of use associated with use of the one or more channels based on the temporal characteristics. The code may cause the one or more processors to control the apparatus to determine the temporal characteristics of spectrum utilization by controlling the device to determine a correlation of at least one signal on the one or more channels. The code may cause the one or more processors to control the apparatus to determine the temporal characteristics of spectrum utilization by controlling the device to determine periodicity of at least one signal on the one or more channels.

The disclosed embodiments also include a first device comprising one or more processors and memory in communication with the one or more processors, the memory including code that, when executed, causes the one or more processors to control the apparatus to monitor first data traffic sent by at least one second device on a contention based channel, determine at least one application type for the first data traffic, and, determine, based on the at least one application type for the first data traffic, at least one back-off parameter for second data traffic sent on the contention based channel. The code may cause the one or more processors to control the apparatus to determine the at least one application type by controlling the device to determine temporal characteristics of spectrum utilization for the first data traffic on the contention based channel, and, determine the at least one application type for the first data traffic based on the temporal characteristics. The code may cause the one or more processors to control the apparatus to determine the temporal characteristics of spectrum utilization by controlling the device to determine a correlation of at least one signal carrying the first data traffic. The code may cause the one or more processors to control the apparatus to determine the temporal characteristics of spectrum utilization by controlling the device to determine a periodicity of at least one signal carrying the first data traffic. The device may further comprise a transceiver coupled to the one or more processors and the code may cause the one or more processors control the apparatus to monitor the first data traffic sent by the at least one second device on the contention based channel using the transceiver. The code may further cause the one or more processors to control the apparatus to transmit the second data traffic from the first device on the contention based channel according to the at least one back-off parameter using the transceiver. The at least one application type may comprise a plurality of application types of first data traffic, each sent by one of a plurality of second devices, and, the code may cause the one or more processors to control the apparatus to determine at least one application type of the plurality of application types of first data traffic by controlling the apparatus to determine a pattern of responses to the first data traffic sent from a third device, determine each application type of the plurality of application types of first data traffic based on the pattern of responses.

The disclosed embodiments further include a system comprising a one or more processors and memory in communication with the ORO or more processors, the memory including a data base and code that, when executed, causes the one or more processors to receive data associated with spectrum usage of one or more channels in at least one network during a first time period, determine at least one parameter associated with the spectrum usage of the one or more channels in the network during the first time period based on the data, determine channel planning information related to spectrum usage of the one or more channels for a second time period based at least on the at least one parameter and historical use information related to spectrum usage of the one or more channels retrieved from the database, and, provide the channel planning information to one or more devices operating in the at least one network. The at least one network may comprise a first and a second network, and the one or more channels may comprise a first one or more channels in the first network and a second one or more channels in the second network, and the channel planning information provided to each of the first and second networks may comprise a joint prediction of spectrum usage based on spectrum usage of both the first and the second one or more channels during the first time period. The at least one network may comprise a first and a second network having separate coverage areas, and the one or more channels may comprise a first one or more channels in the first network and a second one or more channels in the second network, and the channel planning information provided to the first network may comprise a prediction of spectrum usage based on spectrum usage of the first one or more channels during the first time period and the channel planning information provided to the second network may comprise a prediction of spectrum usage based on spectrum usage of the second one or more channels during the first time period.

The disclosed embodiments further include a system comprising a first apparatus having a first coverage area, the apparatus configured to determine first channel planning information for a first one or more channels based on spectrum usage of the first one or more channels during a first time period and information in a first data base, a second apparatus having a second coverage area, the apparatus configured to determine second channel planning information for a second one or more channels based on spectrum usage of the second one or more channels during a second time period and information in a first second base, a first device configured to receive the first channel planning information and communicate on the first one or more channels in the first coverage, area according to the first channel planning information, and, a second device configured to receive the second channel planning information and communicate on the second one or more channels in the first coverage area according to the second channel planning information. The first device and second device may be configured to communicate with one another over a set of channels of the first and second one or more channels, and, the first and second devices may negotiate a selected channel of the set of channels to communicate with one another based on the first and second channel planning information.

Although the subject matter has been described in language specific to structural features and/or methodological operations or acts, it is to be understood that the subject matter defined in the appended claims is not necessarily limited to the specific features, operations, or acts described above. Rather, the specific features, operations, and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may or combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An apparatus comprising:
one or more processors;
memory in communication with the one or more processors, the memory including code that, when executed, causes the one or more processors to control the apparatus to:
receive data on monitored spectrum usage on one or more channels during a first time period;
determine at least one parameter associated with use of the one or more channels during the first time period based on the monitored spectrum usage;
determine a prediction of use of the one or more channels for a second time period based at least on the at least one parameter and information comprising a prediction model; and,
make the prediction available to a device for use in the second time period.

2. The apparatus of claim 1, wherein the at least one parameter comprises at least one duration of use, and the prediction model comprises a history of durations of use of the monitored spectrum in at least one third time period compared to durations of use in at least one fourth time period.

3. The apparatus of claim 1, wherein the at least one parameter comprises at least one type of use, and the prediction model comprises a history of types of use of the monitored spectrum in at least one third time period compared to types of use in at least one fourth time period.

4. The apparatus of claim 1, wherein the at least one parameter comprises at least one type of use and at least one duration of use, and the code further causes the one or more processors to control the apparatus to determine the prediction of use of the one or more channels based on the at least one type of use and the at least one duration of use.

5. The apparatus of claim 1, wherein the one or more channels comprises at first and second one or more channels, and the at least one parameter associated with use of the one or more channels comprises at least one parameter associated with use of the first one or more channels in a first network, and at least one parameter associated with use of the second one or more channels in a second network.

6. The apparatus of claim 1, wherein the at least one parameter comprises at least one type of use and wherein the code causes the one or more processors to control the apparatus to determine the at least one parameter by controlling the apparatus to:
determine temporal characteristics of spectrum utilization associated with use of the one or more channels; and,
determine at least one type of use associated with use of the one or more channels based on the temporal characteristics.

7. The apparatus of claim 6, wherein the code causes the one or more processors to control the apparatus to determine the temporal characteristics of spectrum utilization by controlling the apparatus to determine a correlation of at least one signal on the one or more channels.

8. The apparatus of claim 6, wherein the code causes the one or more processors to control the apparatus to determine the temporal characteristics of spectrum utilization by controlling the apparatus to determine periodicity of at least one signal on the one or more channels.

9. A first device comprising:
one or more processors; and,
memory in communication with the one or more processors, the memory including code that, when executed, causes the one or more processors to control the first device to:
monitor first data traffic sent by at least one second device on a contention based channel;
determine at least one application type for the first data traffic; and,
determine, based on the at least one application type for the first data traffic, at least one back-off parameter for second data traffic sent on the contention based channel.

10. The first device of claim 9, wherein the code causes the one or more processors to control the apparatus to determine the at least one application type by controlling the first device to:
determine temporal characteristics of spectrum utilization for the first data traffic on the contention based channel, and,
determine the at least one application type for the first data traffic based on the temporal characteristics.

11. The first device of claim 10, wherein the code causes the one or more processors to control the apparatus to determine the temporal characteristics of spectrum utilization by controlling the first device to determine a correlation of at least one signal carrying the first data traffic

12. The first device of claim 10 wherein the code causes the one or more processors to control the apparatus to determine the temporal characteristics of spectrum utilization by controlling the first device to determine a periodicity of at least one signal carrying the first data traffic.

13. The first device of claim 9, wherein the device further comprises a transceiver coupled to the one or more processors and the code causes the one or more processors control the apparatus to monitor the first data traffic sent by the at least one second device on the contention based channel using the transceiver.

14. The first device of claim 13, wherein the code further causes the one or more processors to control the apparatus to transmit the second data traffic from the first device on the contention based channel according to the at least one back-off parameter using the transceiver.

15. The first device of claim 9, wherein the at least one application type comprises a plurality of application types for the first data traffic, each sent by one of a plurality of second devices, and, the code causes the one or more processors to control the first to determine at least one application type of the plurality of application types for the first data traffic by controlling the first to:
determine a pattern of responses to the first data traffic sent from a third device;
determine each application type of the plurality of application types of first data traffic based on the pattern of responses.

16. A system comprising:
a one or more processors:
memory in communication with the one or more processors, the memory including a data base and code that, when executed, causes the one or more processors to:
receive data associated with spectrum usage of one or more channels in at least one network during a first time period;
determine at least one parameter associated with the spectrum usage of the one or more channels in the network during the first time period based on the data;
determine channel planning information related to spectrum usage of the one or more channels for a second time period based at least on the at least one parameter and historical use information related to spectrum usage of the one or more channels retrieved from the database; and,
provide the channel planning information to one or more devices operating in the at least one network.

17. The system of claim 16, wherein the at least one network comprises a first and a second network, and the one or more channels comprises a first one or more channels in the first network and a second one or more channels in the second network, and the channel planning information provided to each of the first and second networks comprises a joint prediction of spectrum usage based on spectrum usage of both the first and the second one or more channels during the first time period.

18. The system of claim 16, wherein the at least one network comprises a first and a second network having separate coverage areas, and the one or more channels comprises a first one or more channels in the first network and a second one or more channels in the second network, and the channel planning information provided to the first network comprises a prediction of spectrum usage based on spectrum usage of the first one or more channels during the first time period and the channel planning information provided to the second network comprises a prediction of spectrum usage based on spectrum usage of the second one or more channels during the first time period.

19. A system comprising:
a first apparatus having a first coverage area, the apparatus configured to determine first channel planning information for a first one or more channels based on spectrum usage of the first one or more channels during a first time period and information in a first data base;
a second apparatus having a second coverage area, the apparatus configured to determine second channel planning information for a second one or more channels based on spectrum usage of the second one or more channels during a second time period and information in a first second base;
a first device configured to receive the first channel planning information and communicate on the first one or more channels in the first coverage, area according to the first channel planning information; and,
a second device configured to receive the second channel planning information and communicate on the second one or more channels in the second coverage area according to the second channel planning information.

20. The system of claim 19, wherein the first device and second device are configured to communicate with one another over a set of channels of the first and second one or more channels, and, wherein the first and second devices negotiate a selected channel of the set of channels to communicate with one another based on the first and second channel planning information.
